(19) United States
(12) Patent Application Publication
(10) Pub. No.: US 2023/0213612 A1
(43) Pub. Date: Jul. 6, 2023

(54) METHOD FOR ESTIMATING NOISE IN A RADAR SENSOR

(71) Applicant: Robert Bosch GmbH, Stuttgart (DE)

(72) Inventors: Daniel Koehler, Leonberg (DE); Frank Meinl, Leonberg (DE)

(21) Appl. No.: 18/061,275

(22) Filed: Dec. 2, 2022

(30) Foreign Application Priority Data
Jan. 3, 2022 (DE) 10 2022 200 000.5

(51) Int. Cl. G01S 7/02; G01S 13/931

(52) U.S. Cl. CPC G01S 7/021; G01S 13/931

(57) ABSTRACT

A method for estimating noise in a radar sensor, which generates a digital spectrum which indicates a received signal strength as a function of at least one discrete locating parameter, and on this spectrum a CFAR detection is carried out to decide whether an examined cell in the locating space contains a genuine radar target or just noise and a determination of a noise level is also carried out on the basis of the signal strengths in a selection of neighboring cells in the vicinity of the examined cell. The CFAR detection precedes the determination of the noise level and cells identified in the CFAR detection as target cells are excluded from the selection of the neighboring cells.

### CROSS REFERENCE

The present application claims the benefit under 35 U.S.C. § 119 of German Patent Application No. DE 10 2022 200 000.5 filed on Jan. 3, 2022, which is expressly incorporated herein by reference in its entirety.

### FIELD

The present invention relates to a method for estimating noise in a radar sensor, which generates a digital spectrum which indicates a received signal strength as a function of at least one discrete locating parameter, and on this spectrum a detection, for example a CFAR detection, is carried out to decide whether an examined cell in the locating space contains a genuine radar target or just noise and a determination of a noise level is also carried out on the basis of the signal strengths in a selection of neighboring cells in the vicinity of the examined cell.

Furthermore, the present invention relates to a radar system, in particular for motor vehicles, in which the method is implemented.

### BACKGROUND INFORMATION

In a radar sensor for motor vehicles, a spectrum which indicates a measure of the received signal strength, for example the complex amplitude or the squared amplitude, as a function of the distance and the relative radial velocity of the associated object is typically formed from the received radar echo. In this case, the discrete locating parameters are distance and velocity. The locating space covered by the locating parameters is divided into a plurality of distance/velocity cells and thus forms a two-dimensional matrix in which the associated amplitude is entered for each cell.

Estimating the noise in the radar spectrum is an important factor in radar signal processing, since it makes it possible to calculate the signal-to-noise ratio and to differentiate between target cells and noise cells in the spectrum. In practice, for this purpose constant false alarm rate (CFAR) detectors are used, which, adaptively for each cell in the spectrum, estimate the noise level on the basis of the content of the neighboring cells and use it as the threshold value. In this case, the two most widely used methods are cell-averaging CFAR (CA-CFAR) (A. Farina, F. A. Studer, “A Review of CFAR Detection Techniques in Radar Systems,” Microwave Journal, 1986, pages 115-128) and ordered-statistics CFAR (OS-CFAR) (S. Blake, “OS-CFAR theory for multiple targets and nonuniform clutter,” IEEE Transactions on Aerospace and Electronic Systems, 1988, pages 785-790).

More complex methods, such as greatest-of CFAR (GO-CFAR) (X. Meng, Y. He, “Two generalized greatest of selection CFAR algorithms,” CIE International Conference on Radar Proceedings, 2001, pages 359-362) or adaptive linear combined CFAR (ALC-CFAR) (B. Magaz, A. Belouchrani, “A New Adaptive Linear Combined CFAR Detector in Presence of Interfering Targets,” Progress in Electromagnetics Research B, 2011, pages 367-387), expand upon or combine approaches from CA-CFAR and OS-CFAR in order to form different estimated values for the noise which are then used to establish the threshold value by selection or combination.

A weakness inherent to CFAR detectors in relation to the noise estimation is that the signal power reflected by targets is incorporated in the noise calculation. This is because, in CFAR detectors, either the estimated noise value is first formed and only after that is a differentiation made between noise cells and target cells in the spectrum, or the estimated noise value implicitly feeds into the differentiation between noise cells and target cells. All the cells therefore have to be taken into account in the noise estimation with the same weighting, since there is still no information available as to the cells in which actual targets are located. As a result, the noise in the spectral vicinity of targets tends to be estimated to be too high.

### SUMMARY

An object of the present invention is to provide a method that makes it possible to estimate noise more realistically.

According to the present invention, this object may be achieved in that the detection precedes the determination of the noise level and in that cells identified in the detection as target cells are excluded from the selection of the neighboring cells for the noise estimation.

This prevents the high signal values in the target cells from distorting the noise estimation.

Advantageous embodiments and developments of the present invention are disclosed herein.

In a first stage, a conventional CFAR detector can be used to differentiate between noise cells and target cells. The type of CFAR used in this case can generally be selected as desired and can be established depending on the application.

In radar systems for motor vehicles, for example, the use of OS-CFAR is preferred over CA-CFAR, since OS-CFAR is more robust when faced with multi-target environments, as often arise in urban scenarios.

Furthermore, other detectors which do not operate using the CFAR principle can also be used in the first stage. For example, as a very simple configuration, a constant detection threshold can be used for differentiating between noise cells and target cells.

Any estimated noise value that is formed in the first stage to establish the threshold value, for example by a CFAR detector, is no longer of interest, since the noise is determined in the second stage by a dedicated noise estimator. This also makes it possible to use CFAR implementations that implicitly calculate the threshold value. These include, for example, “rank-only OS-CFAR” (M. R. Bales, T. Benson, R. Dickerson, D. Campbell, R. Hersey, and E. Culpepper, “Real-time implementations of ordered-statistic CFAR,” IEEE Radar Conference, 2012, pages 896-901), which allows for efficient hardware implementation without explicit noise estimation.

According to an example embodiment of the present invention, in a second stage, dedicated noise estimation then takes place, for example on the basis of the following input data:
spectrum P, for example distance/velocity spectrum, in the form of a m×n matrix
detection information D for each cell in the form of a Boolean m×n matrix in which D=1 corresponds to a target cell and D=0 corresponds to a noise cell.

However, the use of two-dimensional data structures is not mandatory. Additional dimensions, such as multiple receiving channels in conjunction with digital beamformers, can also be used. One-dimensional data structures can likewise be used without restrictions.

To form the estimated value, a window having a fixedly parametrized size N can be shifted over the spectrum, for example. In cells in the window which have been classified by the upstream CFAR detector as target cells, the spectral value of the cell is then ignored and is, for example, replaced with an estimated noise value for one or more cells in the neighborhood for which the result of the noise estimation is already available. The estimated noise value for the cell currently being examined is then, for example, calculated by producing the moving average of the N^{th} order over all the cells in the window. This averaging can expediently be performed in an iterative process.

In a further specific embodiment of the present invention, the size of the window N is reduced by the number of cells N_{D} that have been classified as target cells and are located within the window at the time of the noise estimation. The resulting window then contains only noise cells, meaning that it is no longer necessary to use previous noise-estimation results from the neighborhood. The estimated noise value for the cell currently being examined could then be based on the average of the (N−N_{D})^{th} order, for example.

In a third specific embodiment of the present invention, as in the previous example, all the cells classified as target cells are removed from the window. However, instead of the noise estimation then being performed on the remaining (N−N_{D}) cells, the window is enlarged in the neighborhood until it contains exactly N cells again. The resulting window then consists only of noise cells and the resulting estimated noise value is always based on N input values.

The window used for the noise estimation can be one-dimensional (e.g., only along the velocity axis) or can be two-dimensional or multi-dimensional.

Depending on the specific embodiment of the present invention, the cell to be examined can be in the center, at an end, or in a corner of the window.

In a hardware implementation of the present invention, a shift register or a first-in, first-out (FIFO) memory is expediently provided for representing the window.

The number N of cells in the window is preferably a power of two, since the division by N can then be carried out simply and efficiently by a bit shift during the averaging.

An exemplary embodiment of the present invention is explained in greater detail in the following with reference to the figures.

### BRIEF DESCRIPTION OF THE DRAWINGS

FIG. 1 is a block diagram of a radar system in which a method according to an example embodiment of the present invention is implemented.

FIG. 2 is a circuit diagram of an implementation of a rank-only OS-CFAR detector, according to an example embodiment of the present invention.

FIG. 3 shows two different states of a sliding window, according to an example embodiment of the present invention.

FIG. 4 is a circuit diagram of an implementation of a noise estimator, according to an example embodiment of the present invention.

### DETAILED DESCRIPTION OF EXAMPLE EMBODIMENTS

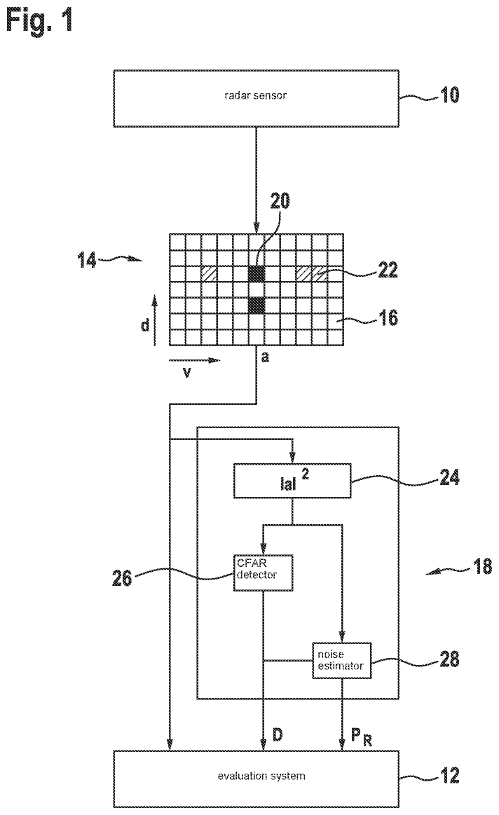

FIG. 1 shows a block diagram of a radar system for a motor vehicle, which radar system comprises a radar sensor 10 and an electronic evaluation system 12. The radar sensor 10, for example a frequency-modulated continuous-wave (FMCW) radar, converts the received analog radar signals into digital signals and forms from these, using a fast Fourier transform, a discrete two-dimensional spectrum 14 in which one dimension represents the distance d from a located object and the other dimension represents the radial relative velocity v of the object. If an object having the distance d and the relative velocity v is located, this is shown in the spectrum 14 as a local maximum of the signal strength at the point (d, v) in the spectrum. The locating space covered by the distance and velocity dimensions is divided into a number of cells 16, which each correspond to a specific distance range and a specific velocity range and together form an n×m matrix. Each cell 16 is assigned a spectral value a, which indicates the signal strength in the relevant cell. For example, the spectral value a is a complex amplitude which contains both amplitude and phase information.

The evaluation system 12 also comprises a CFAR and noise detection unit 18, which is shown in the form of a separate block in FIG. 1 and has to fulfill two interrelated objectives. A first objective is to make a decision, for each of the cells 16 in the spectrum, as to whether the cell contains a radar target or whether the signal received for this cell merely constitutes noise. In the former case the cell is referred to as a target cell 20, and in the latter case it is referred to as a noise cell 22. The second objective is to estimate a local noise level P_{R} for each cell 16.

The decision as to whether or not a given cell is a target cell provides a binary detection result D, i.e., a variable which has the value 1 when the cell is a target cell and has the value 0 when it is a noise cell. In principle, the detection result D is obtained by calculating the squared amplitude |a|² in a quadratic module 24 from the complex amplitude a in the cell to be examined and then comparing this squared amplitude with a suitable threshold value. This means that a cell is only classified as a target cell 20 if the squared amplitude is above a threshold value selected in light of the local noise level P_{R} such that the threshold value is only exceeded if the signal strength is markedly above the noise level. Since the local noise level can be the reason for fluctuations in time and space, the estimated values for the noise level and the threshold values derived therefrom need to be dynamically adjusted during operation of the radar system.

In the method according to the present invention, however, the squared amplitude is first supplied to a CFAR detector 26, which provides the detection result D for each cell. This detection result D is transmitted to downstream instances of the evaluation system 12, but also to a noise estimator 28, which uses this detection result to estimate the noise level P_{R} on the basis of the squared amplitude. The noise level thus obtained is then transmitted to downstream instances of the evaluation system 12 and can, for example, be used to assess the quality of the locating result of the radar sensor and/or to update, in a subsequent measurement cycle, the threshold values used in the CFAR detector 26. The complex amplitudes a from the spectrum 14 are also transmitted in parallel therewith directly to the downstream instances of the evaluation system 12, where they can be used together with corresponding amplitudes for other receiving channels for angle estimation of the located targets.

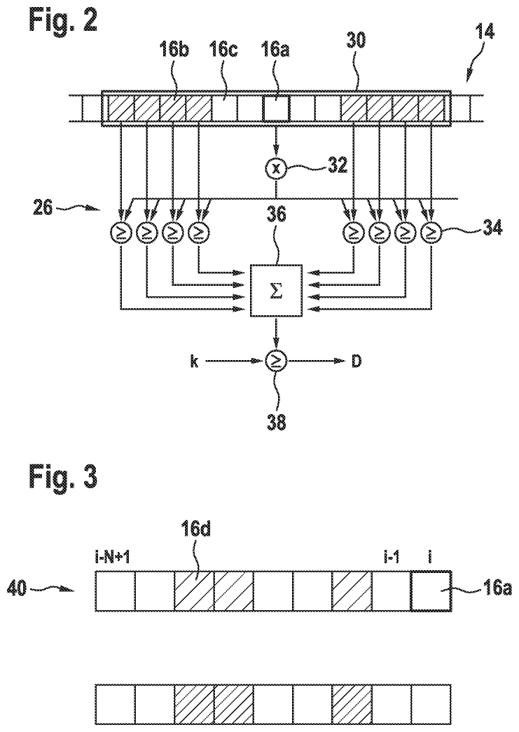

FIG. 2 shows a possible implementation of the CFAR detector 26 as a rank-only OS-CFAR. The input data are the squared amplitudes of the spectral values from the spectrum 14, of which a section of a row of the cell matrix is shown in FIG. 2. In the example shown, a one-dimensional window 30, which surrounds a specific number of neighboring cells, is shifted over the cell matrix of the spectrum 14 such that each cell 16 of the spectrum in succession is granted the status of an “examined cell” 16a located in the center of the window 30. The examined cell 16a is flanked by window cells 16b of which the spectral values feed into the decision as to whether the examined cell 16a is a target cell or a noise cell. In the example shown, the window additionally still has a number of protective cells 16c which are symmetrical to the examined cell 16a and of which the spectral values are not evaluated. In the case of expansive objects extending over a plurality of cells, this is intended to prevent the cells that neighbor the examined cell 16a and likewise have a high signal strength if the examined cell is a target cell from being mistakenly interpreted as noise background and distorting the detection result. In each position of the window 30 on the cell matrix, the spectral value of the examined cell 16a is then multiplied by a suitable scaling factor using a multiplier 32, and the spectral value scaled in this way is compared with the (unscaled) spectral values of the window cells 16b in comparators 34. In a summer 36, the binary comparison results over all the window cells are added together. In a further comparator 38, the resulting sum is compared with a so-called rank k, which, in practice, can have a predetermined value, for example k=3N/4, where N is the number of window cells. When the sum is greater than k, this means that the spectral value of the examined cell 16a is greater than the spectral value of most of the window cells, and therefore that the signal strength in the examined cell 16a markedly contrasts with the noise background provided by the signal strengths of the window cells. In this case, it is therefore decided that the examined cell 16a is a target cell, and the detection result D is given the value 1. Otherwise, the detection result D is given the value 0, which means that the examined cell 16a is classified as a noise cell.

The level of the constant false alarm rate can be parameterized according to the desired application by way of the scaling factor for the multiplier 32, as well as the rank k and the window size N.

FIG. 3 shows an example of a window 40 that is used in the noise estimator 28 for the noise estimation and does not need to be identical to the window 30 from FIG. 2. In the example shown, the window 40 is also a one-dimensional window, although the examined cell 16a is not in the center but instead is located at an end of the window. An index i indicates the row index of the cell matrix of the spectrum 14. The window 40 contains N cells having the indices i−N+1, i−N+2, . . . , i−1, i. When the index i is increased stepwise by the increment 1, this means that the window 40 is shifted over the cell matrix in the row direction, and specifically in the direction of the increasing row indices, meaning that the examined cell 16a forms the leading end of the window.

In general, the spectral values of the cells in the window 40 form the basis for the estimation of the local noise level. In the example shown, however, the window 40 not only contains noise cells, but also target cells 16d, which are hatched here. In conventional methods, at the time of the noise estimation it is not yet known whether or not the window 40 contains target cells, and therefore all the cells have to be considered to be noise cells. In the method according to the present invention, however, the detection result D is already available for the cells currently located in the window 40, and therefore the target cells 16d can be identified on the basis of this detection result. In FIG. 3, for example, the cell in the position i−2 is a target cell, while the cell in the position i−3 is a noise cell. The examined cell 16a is the cell for which the noise estimation is currently being performed. Since the window 40 moves from right to left over the cell matrix as the index i increases, the noise estimation has already taken place for the cells in the positions i−2, i−3, etc. So that the high signal levels in the target cells 16d do not feed into the noise estimation, the spectral value (the square of the absolute value) of the target cells is replaced with the estimated noise value for the closest noise cell in each case. In FIG. 3, this replacement is indicated by the different hatching in the cells in the lower window, which represents the state after the replacement.

The actual noise estimation can then be performed by forming the average of the spectral values over all the cells of the window once the above-described replacement has taken place. When P_{R}(i) is the estimated value to be determined for the cell 16a currently being examined, F(j) is the (optionally replaced) spectral value of the cell having the index j, and N is the number of cells of the window, the following applies:

$${P}_{R} ( i ) = \frac{1}{N} {\sum }_{j = i - N + 1}^{i} F ( j ) \qquad ( 1 )$$

The above-described replacement of the spectral values and the averaging can, however, be performed efficiently in a considerably lower number of computing operations when the calculation is performed iteratively:

when D(i)=0:

P_{R}(i)=P_{R}(i−1)+(1/N)(P(i)−F(i−N) (2)

when D(i)=1:

P_{R}(i)=P_{R}(i−1)+(1/N)(P_{R}(i—l)−F(i−N) (3)

where P(i) is the spectral value in the cell having the index i.

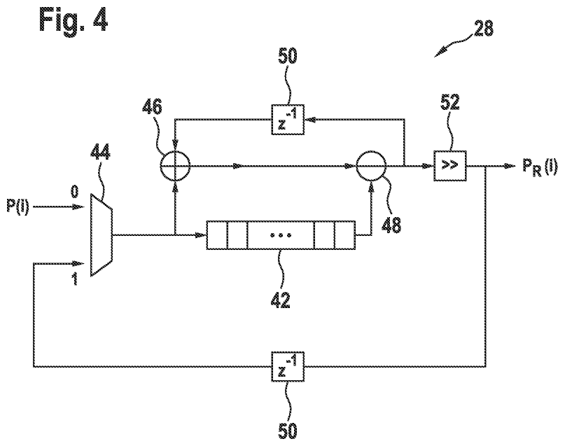

A possible hardware implementation of this iterative estimation process is shown in the form of a block diagram in FIG. 4. The noise estimator 28 shown in this figure comprises a shift register 42 having N memory locations, where N is a power of two: N=2^{P}. The spectral values P(i) (squared amplitudes) of the cells 16 are supplied in succession to a multiplexer 44 at the input of the shift register 42, together with the detection result D (0 or 1) for the relevant cell. Depending on this detection result, a decision is made as to whether formula (2) or formula (3) should be applied.

An adder 46 and a subtractor 48 form the difference between the first and the last memory location in the shift register 42, and delayers 50 control the transition from the index i to the previous index i−1. The division by N in accordance with formula (2) or formula (3) is performed in a very efficient manner with the aid of a simple bit shifter 52, which shifts the relevant binary value by p (base-2 logarithm of N). In this way, the noise estimator 28 delivers the associated estimated value P_{R}(i) for each of the successive values of the index i.

What is claimed is:

1. A method for estimating noise in a radar sensor, which generates a digital spectrum which indicates a received signal strength as a function of at least one discrete locating parameter, the method comprising:
carrying out, on the spectrum, a detection to decide whether an examined cell in a locating space contains a genuine radar target or just noise; and
determining a noise level based on the signal strengths in a selection of neighboring cells in the vicinity of the examined cell;
wherein the detection precedes the determination of the noise level, and cells identified in the detection as target cells are excluded from the selection of the neighboring cells.

2. The method as recited in claim 1, wherein the detection is a CFAR detection.

3. The method as recited in claim 1, wherein, in the determination of the noise level, the signal strengths of the excluded neighboring cells are each replaced with an existing estimated noise value for a cell in a vicinity.

4. The method as recited in claim 1, wherein, in the determination of the noise level, a magnitude of a number of cells in the selection of the neighboring cells is reduced in accordance with a number of excluded neighboring cells.

5. The method as recited in claim 1, wherein, in the determination of the noise level, the signal strengths of the excluded neighboring cells are each replaced with signal values for nearby cells from an enlarged neighborhood.

6. The method as recited in claim 1, wherein the locating space is at least two-dimensional.

7. The method as recited in claim 2, wherein the CFAR detection is carried out in accordance with an OS-CFAR algorithm.

8. The method as recited in claim 7, in which the CFAR detection is carried out in accordance with a rank-only OS-CFAR algorithm.

9. The method as recited in claim 1, wherein, for the determination of the noise level, a window that has a size of N cells of the locating space is shifted over a matrix of the cells of the locating space and, at each position of the window, a cell contained in the window is the examined cell and remaining cells are the neighboring cells.

10. The method as recited in claim 9, wherein the window is one-dimensional.

11. The method as recited in claim 9, wherein the window is one-dimensional, the examined cell is located at one end of the window and, the window is moved over the cell matrix such that the end at which the examined cell is located traverses each cell of the cell matrix before any other part of the window.

12. The method as recited in claim 9, wherein the window is a multi-dimensional window, the examined call is located in a corner of the window, and the window is moved over the cell matrix such that the corner at which the examined cell is located traverses each cell of the cell matrix before any other part of the window.

13. The method as recited in claim 9, wherein estimated values for the noise level of successive cells are calculated iteratively.

14. The method as recited in claim 9, wherein N is a power of two.

15. The method as recited in claim 9, wherein the window size N varies depending on a current position of the window.

16. The method as recited in claim 9, wherein individual cells are hidden within the window such that they do not contribute to the noise estimation.

17. A radar system, comprising:
a radar sensor; and
an electronic evaluation system;
wherein the radar sensor is configured to generate a digital spectrum which indicates a received signal strength as a function of at least one discrete locating parameter; and
wherein the electronic evaluation system is configured to:
carry out, on the spectrum, a detection to decide whether an examined cell in a locating space contains a genuine radar target or just noise; and
determine a noise level based on the signal strengths in a selection of neighboring cells in the vicinity of the examined cell;
wherein the detection precedes the determination of the noise level, and cells identified in the detection as target cells are excluded from the selection of the neighboring cells.

18. The radar system as recited in claim 17, wherein the evaluation system includes a noise estimator, which includes a FIFO memory having N memory cells and a bit shifter, where N is a power of two.
